(19) United States
(12) Patent Application Publication
(10) Pub. No.: US 2017/0029613 A1
(43) Pub. Date: Feb. 2, 2017

(54) THREE-DIMENSION FORMING MATERIAL, THREE-DIMENSION FORMING SUPPORT MATERIAL, AND THREE-DIMENSION FORMING COMPOSITION SET

(71) Applicant: FUJI XEROX CO., LTD., Tokyo (JP)

(72) Inventors: Takashi OYANAGI, Kanagawa (JP); Takashi MORIKAWA, Kanagawa (JP); Toshitake YUI, Kanagawa (JP)

(73) Assignee: FUJI XEROX CO., LTD., Tokyo (JP)

(21) Appl. No.: 15/130,264

(22) Filed: Apr. 15, 2016

(30) Foreign Application Priority Data
Jul. 31, 2015 (JP) 2015-152853

(51) Int. Cl. C08L 35/02

(52) U.S. Cl. CPC C08L 35/02; B33Y 70/00

(57) ABSTRACT

A three-dimension forming material includes a radiation curable compound and has a total concentration of a magnesium ion and a calcium ion of 50 ppm or less, a concentration of an alkali metal ion of 100 ppm or less, and a concentration of a fatty acid compound of 50 ppm or less.

### CROSS-REFERENCE TO RELATED APPLICATIONS

This application is based on and claims priority under 35 USC 119 from Japanese Patent Application No. 2015-152853 filed Jul. 31, 2015.

### BACKGROUND

1. Technical Field

The present invention relates to a three-dimension forming material, a three-dimension forming support material, and a three-dimension forming composition set.

2. Related Art

The three-dimension forming apparatus, also called as a 3D printer, for example, is known as an apparatus for fabricating a three-dimensional structure (for example, parts of industrial products, toys such as dolls, and the like) in which the three-dimensional structure is fabricated by repeating the following processes of: disposing a forming material (model material) using an ink jet method according to three-dimensional sectional data (CAD data), and curing the material with an ultraviolet ray (UV) or an electron beam (EB).

In the three-dimension forming apparatus, in order to form a freely-shaped three-dimensional structure, in the case of forming an overhang or ceiling, a support material for forming a support portion supporting the lower portion of the forming material is required.

Here, various three-dimension forming apparatuses and methods for preparing a three-dimensional structure are suggested.

### SUMMARY

According to an aspect of the invention, there is provided a three-dimension forming material,

including a radiation curable compound, and

having a total concentration of a magnesium ion and a calcium ion of 50 ppm or less, a concentration of an alkali metal ion of 100 ppm or less, and a concentration of a fatty acid compound of 50 ppm or less.

### BRIEF DESCRIPTION OF THE DRAWINGS

Exemplary embodiments of the present invention will be described in detail based on the following figures, wherein:

FIG. 1 is a configuration diagram schematically illustrating one example of a three-dimension forming apparatus according to the exemplary embodiment;

FIG. 2A is a process diagram illustrating one example of a method for preparing a three-dimensional structure according to the exemplary embodiment;

FIG. 2B is a process diagram illustrating one example of a method for preparing a three-dimensional structure according to the exemplary embodiment; and

FIG. 2C is a process diagram illustrating one example of a method for preparing a three-dimensional structure according to the exemplary embodiment.

### DETAILED DESCRIPTION

Hereinafter, the exemplary embodiment as one example of the present invention will be described in detail.

Three-dimension forming material

The three-dimension forming material (hereinafter, referred to as “model material”) according to the exemplary embodiment contains a radiation curable compound, in which the total concentration of a magnesium ion and a calcium ion is 50 ppm or less (preferably 45 ppm or less), the concentration of an alkali metal ion is 100 ppm or less (preferably 95 ppm or less), and the concentration of a fatty acid compound is 50 ppm or less (preferably 45 ppm or less). In addition, in the present specification, the concentration of a metal ion and the fatty acid compound is a concentration with respect to the entirety of the model material. In addition, ppm is based on a weight. The same applies to the following.

Here, the magnesium ion and the calcium ion are bonded to a fatty acid compound to forma sparingly soluble metal soap (fatty acid metal salt). This sparingly soluble metal soap (fatty acid metal salt) is difficult to be dissolved in a water phase and an oil phase and is precipitated to form a granular substance (solid particle, gel particle, or the like), and there is a tendency that the granular substance functions as a nucleus and the metal soap grows to increase in size. Thus, if the sparingly soluble metal soap is formed in the model material, the metal soap is precipitated as a granular substance on the surface of a three-dimensional structure. In addition, when coating the three-dimensional structure, the granular substance existing on the surface of the three-dimensional structure causes repelling of a coating material or coating unevenness of the coating material, which may deteriorate coating properties of the three-dimensional structure.

In addition, the alkali metal ion also is bonded to the fatty acid compound to form a sparingly soluble metal soap (fatty acid metal salt). The sparingly soluble metal soap (fatty acid metal salt) is less sparingly soluble with respect to the water phase or the oil phase and exhibits solubility, compared to the sparingly soluble metal soap (fatty acid metal salt) formed from the magnesium ion or calcium ion and the fatty acid compound. However, if the sparingly soluble metal soap (fatty acid metal salt) is formed, the granular substance is easily formed and the granular substance may be precipitated on the surface of the three-dimensional structure.

Therefore, in the model material according to the exemplary embodiment, the total concentration of the magnesium ion and the calcium ion, the concentration of the alkali metal ion, and the total concentration of the fatty acid compound, which causes the formation of the sparingly soluble metal soap (fatty acid metal salt), are reduced within the aforementioned range. By doing this, in the model material, the formation of the sparingly soluble metal soap (fatty acid metal salt) is prevented and the precipitation of the metal soap as the granular substance on the surface of the three-dimensional structure is prevented. Thus, the model material prevents reduction of the coating properties of the three-dimensional structure.

In addition, if the sparingly soluble metal soap (fatty acid metal salt) is formed and the granular substance is formed as a foreign matter, in a discharge unit (for example, an ink jet head) for discharging the model material, discharge failures such as clogging of nozzles, reduction of a discharge amount, deviation of a discharge direction, or the like may occur. Also, the foreign matter is captured by a filter within an apparatus, which causes clogging or blocking of the filter, and the discharge failures such as no-discharge may occur. However, in the model material according to the exemplary embodiment, since the formation of the sparingly soluble metal soap (fatty acid metal salt) is prevented, these discharge failures are prevented as well.

In the model material according to the exemplary embodiment, incorporation of various metal ions such as the magnesium ion, calcium ion, and alkali metals (lithium, sodium, potassium, rubidium, cesium, or the like) into the model material is mainly caused by a coloring material (in particular, a pigment). The coloring material (in particular, a pigment) includes metal ions derived from its preparing process. Thus, by sufficiently refining and washing the coloring material (in particular, a pigment), it is possible to reduce the concentration of the various metal ions in the model material within the aforementioned range.

In addition, there are less causes of incorporating divalent or higher valent metal ions other than the magnesium ion and the calcium ion (metal ions of alkali earth metals and transition metals such as strontium, barium, iron, zinc, copper, aluminum, manganese) into the model material. However, the divalent or higher valent metal ion other than the magnesium ion and the calcium ion is also bonded to the fatty acid compound to form a sparingly soluble metal soap (fatty acid metal salt). Therefore, it is preferable that the concentration of the divalent or higher valent metal ion other than the magnesium ion and the calcium ion is 50 ppm or less (preferably 45 ppm or less).

Here, the divalent or higher valent metal ion including the magnesium ion and calcium ion has a function of agglomerating the coloring material (in particular, a pigment), which may cause the discharge failures. Therefore, if the concentration of the divalent or higher valent metal ion including the magnesium ion and the calcium ion is reduced to 50 ppm or less, agglomeration of the coloring material (in particular, a pigment) is prevented and the discharge failures are prevented.

Here, the concentration of the various metal ions is measured by using an inductively coupled plasma (ICP) emission spectral analysis. Specifically, the measurement is as follows. First, 10 ml of the model material is fractionated in a centrifuge tube, 40 ml of t-butyl ethyl ether is added thereto, and sufficient mixing is performed by stirring. After that, centrifugation is performed for 30 minutes at 10,000 rpm. 5 ml of a supernatant liquid is fractionated in a crucible made of quartz and the resultant is dried at a temperature of 60° C. for 24 hours within an explosion proof drier. After that, the resultant is heated at a temperature of 500° C. for 5 hours in an electric furnace and combusted, and then 0.5 mol/l of a nitric acid aqueous solution is added thereto to prepare an analysis sample. Then, the analysis sample is analyzed by the inductively coupled plasma (ICP) emission spectral analysis to measure the concentration of the various metal ions. In addition, ICPS-7510 manufactured by Shimadzu Corporation is used for analysis.

Meanwhile, the fatty acid compound is a compound having a structure derived from a fatty acid “a structure in which a hydrogen atom is removed from a carboxyl group of the fatty acid: R—C(═O)O— structure (wherein R represents an aliphatic group, for example, an aliphatic group having 6 to 22 carbon atoms)”. Examples of the fatty acid compound include fatty acids (stearic acid, 12-hydroxystearic acid, lauric acid, ricinoleic acid, behenic acid, octylic acid, montanoic acid, myristic acid, palmitic acid, sebacic acid, undecylenic acid, or the like) and fatty acid derivatives. Examples of the fatty acid derivatives include fatty acid ester, fatty acid amide, and a fatty acid metal salt. In addition, examples of the fatty acid compound whose concentration is to be reduced to 50 ppm or less include a fatty acid metal salt which causes deterioration in coating properties of the three-dimensional structure and the discharge failures.

In addition, the incorporation of the fatty acid compound into the model material is mainly caused by contact between the model material or a raw material thereof and a plastic product. The fatty acid compound is used as an additive or a release agent at the time of molding the plastic product. That is, if equipment made of plastic is used or the model material is accommodated into a container made of plastic when the model material is prepared, the fatty acid compound is easily incorporated into the model material. Thus, it is possible to reduce the concentration of the fatty acid compound in the model material within the above range by reducing the contact between the model material or a raw material thereof and the plastic product using the model material.

Here, the concentration of the fatty acid compound is measured using a gas chromatography mass spectrometry (GC-MS method) after esterification of the fatty acid compound. In a case where the fatty acid compound is a fatty acid ester, the concentration is measured using a gas chromatography mass spectrometry (GC-MS method) as it is. Specifically, the measurement is as follows. 2 ml of a 2 mol/l potassium hydroxide methanol solution is added to 10 ml of a n-hexane solution containing the fatty acid compound, the resultant is stirred for 2 minutes, and 1 ml of an upper layer of the solution separated into 2 layers is fractionated. 9 ml of n-hexane is added thereto to prepare 10 ml of an analysis sample. Then, the analysis sample is analyzed by the GC-MS method to measure the concentration of the fatty acid compound. In addition, GC/MS (GC-2010/GCMSQP2010) manufactured by Shimadzu Corporation is used for analysis.

Hereinafter, components of the model material according to the exemplary embodiment will be described in detail.

The model material according to the exemplary embodiment contains a radiation curable compound. The model material may contain other additives such as a radiation polymerization initiator, a polymerization inhibitor, a surfactant, and a coloring material, in addition to the aforementioned components.

Radiation Curable Compound

The radiation curable compound is a compound which is cured (polymerized) by radiation (for example, an ultraviolet ray or an electron beam). The radiation curable compound may be a monomer or an oligomer.

Examples of the radiation curable compound include compounds having a radiation curable functional group (a radiation polymerizable functional group). Examples of the radiation curable functional group include an ethylenically unsaturated double bond (for example, a N-vinyl group, a vinyl ether group, a (meth)acryloyl group, or the like), an epoxy group, and an oxetanyl group. As the radiation curable compound, a compound having an ethylenically unsaturated bond group (preferably a (meth)acryloyl group) is preferable.

Specifically, examples of the radiation curable compound preferably include urethane (meth)acrylate, epoxy(meth)acrylate, and polyester(meth)acrylate. Among the above, as the radiation curable compound, urethane(meth)acrylate is preferable.

In addition, in the present specification, (meth)acrylate means both acrylate and methacrylate. In addition, (meth)acryloyl means both an acryloyl group and a methacryloyl group.

Urethane(meth)acrylate

Urethane(meth)acrylate (hereinafter, simply “urethane(meth)acrylate”) is a compound having a urethane structure and 2 or more (meth)acryloyl groups within one molecule. The urethane(meth)acrylate may be a monomer or an oligomer, but the oligomer is preferable.

The functional number of the urethane(meth)acrylate (the number of the (meth)acryloyl groups) is preferably from 2 to 20 (more preferably from 2 to 15).

Examples of the urethane(meth)acrylate include reaction products using a polyisocyanate compound, a polyol compound, and (meth)acrylate containing a hydroxyl group. Specifically, examples of the urethane(meth)acrylate include reaction products of a prepolymer having an isocyanate group at the terminal and (meth)acrylate containing a hydroxyl group, the prepolymer being obtained by reacting the polyisocyanate compound and the polyol compound. In addition, examples of the urethane(meth)acrylate include reaction products of the polyisocyanate compound and (meth)acrylate containing a hydroxyl group.

Polyisocyanate Compound

Examples of the polyisocyanate compound include chain saturated hydrocarbon isocyanate, cyclic saturated hydrocarbon isocyanate, and aromatic polyisocyanate. Among the above, as the polyisocyanate compound, the chain saturated hydrocarbon isocyanate which does not have a light absorption band in a near ultraviolet region, and cyclic saturated hydrocarbon isocyanate which does not have a light absorption band in a near ultraviolet region are preferable.

Examples of the chain saturated hydrocarbon isocyanate include tetramethylene diisocyanate, hexamethylene diisocyanate, 2,2,4-trimethylhexamethylene diisocyanate, and 2,4,4-trimethylhexamethylene diisocyanate.

Examples of the cyclic saturated hydrocarbon isocyanate include isophorone diisocyanate, norbornane diisocyanate, dicyclohexyl methane diisocyanate, methylene bis(4-cyclohexyl isocyanate), hydrogenated diphenyl methane diisocyanate, hydrogenated xylene diisocyanate, and hydrogenated toluene diisocyanate.

Examples of the aromatic polyisocyanate include 2,4-tolylene diisocyanate, 1,3-xylylene diisocyanate, p-phenylene diisocyanate, 3,3′-dimethyl-4,4′-diisocyanate, 6-isopropyl-1,3-phenyl diisocyanate, and 1,5-naphthalene diisocyanate.

Polyol Compound

Examples of the polyol compound include diol and polyol.

Examples of diol include alkylene glycol (for example, ethylene glycol, 1,2-propanediol, 1,3-propanediol, 2-methyl-1,3-propanediol, 1,3-butanediol, 1,4-butanediol, 1,5-pentanediol, 2-methyl-1,5-pentanediol, neopentyl glycol, 3-methyl-1,5-pentanediol, 2,3,5-trimethyl-1,5-pentanediol, 1,6-hexanediol, 2-ethyl-1,6-hexanediol, 2,2,4-trimethyl-1,6-hexanediol, 1,8-octanediol, 1,9-nonanediol, 1,10-decanediol, 1,12-dodecanediol, 1,14-tetradecanediol, 1,16-hexadecanediol, 1,2-dimethylolcyclohexane, 1,3-dimethylolcyclohexane, and 1,4-dimethylolcyclohexane).

Examples of polyol include alkylene polyol having 3 or more hydroxyl groups (for example, glycerin, trimethylolethane, trimethylolpropane, 1,2,6-hexanetriol, 1,2,4-butanetriol, erythritol, sorbitol, pentaerythritol, dipentaerythritol, and mannitol).

Examples of the polyol compound also include polyether polyol, polyester polyol, and polycarbonate polyol.

Examples of the polyether polyol include a multimer of polyol, adducts of polyol and alkylene oxide, and a ring opening polymer of alkylene oxide.

Here, examples of the polyol include ethylene glycol, diethylene glycol, propylene glycol, dipropylene glycol, 1,4-butanediol, 1,3-butanediol, neopentyl glycol, 1,6-hexanediol, 1,2-hexanediol, 3-methyl-1,5-pentanediol, 2-butyl-2-ethyl-1,3-propanediol, 2,4-diethyl-1,5-pentanediol, 1,8-octanediol, 1,9-nonanediol, 2-methyl-1,8-octanediol, 1,8-decanediol, octadecanediol, glycerin, trimethylolpropane, pentaerythritol, and hexanetriol.

Examples of the alkylene oxide include ethylene oxide, propylene oxide, butylene oxide, styrene oxide, epichlorohydrin, and tetrahydrofuran.

Examples of the polyester polyol include reaction products of polyol and dibasic acid, and a ring opening polymer of a cyclic ester compound.

Here, examples of the polyol include polyol exemplified in the description of the polyether polyol.

Examples of the dibasic acid include a carboxylic acid (for example, a succinic acid, an adipic acid, a sebacic acid, a dimer acid, a maleic acid, a phthalic acid, a isophthalic acid, and a terephthalic acid), and anhydrides of the carboxylic acid.

Examples of the cyclic ester compound include ε-caprolactone and β-methyl-δ-valerolactone.

Examples of the polycarbonate polyol include a reaction product of glycol and alkylene carbonate, a reaction product of glycol and diaryl carbonate, and a reaction product of glycol and dialkyl carbonate.

Here, examples of the alkylene carbonate include ethylene carbonate, 1,2-propylene carbonate, and 1,2-butylene carbonate. Examples of the diaryl carbonate include diphenyl carbonate, 4-methyl diphenyl carbonate, 4-ethyl diphenyl carbonate, 4-propyl diphenyl carbonate, 4,4′-dimethyl diphenyl carbonate, 2-tolyl-4-tolyl carbonate, 4,4′-diethyl diphenyl carbonate, 4,4′-dipropyl diphenyl carbonate, phenyl toluyl carbonate, bischlorophenyl carbonate, phenyl chlorophenyl carbonate, phenyl naphthyl carbonate, and dinaphthyl carbonate.

Examples of the dialkyl carbonate include dimethyl carbonate, diethyl carbonate, di-n-propyl carbonate, diisopropyl carbonate, di-n-butyl carbonate, diisobutyl carbonate, di-t-butyl carbonate, di-n-amyl carbonate, and diisoamyl carbonate.

(Meth)Acrylate Containing a Hydrogen Group

Examples of the (meth)acrylate containing a hydrogen group include 2-hydroxyethyl(meth)acrylate, 2-hydroxypropyl(meth)acrylate, 2-hydroxybutyl(meth)acrylate, 2-hydroxy-3-phenoxypropyl(meth)acrylate, glycerin di(meth)acrylate, trimethylolpropane di(meth)acrylate, pentaerythritol tri(meth)acrylate, and dipentaerythritol penta(meth)acrylate. Examples of the (meth)acrylate containing a hydrogen group include adducts of a compound containing a glycidyl group (for example, alkyl glycidyl ether, allyl glycidyl ether, and glycidyl(meth)acrylate) and (meth)acrylic acid.

Weight average molecular weight of urethane(meth)acrylate

The weight average molecular weight of the urethane(meth)acrylate is preferably from 500 to 5,000 and more preferably from 1,000 to 3,000.

The weight average molecular weight of the urethane(meth)acrylate is a value measured by gel permeation chromatography (GPC) using polystyrene as a reference substance.

Other Radiation Curable Compounds

Examples of the radiation curable compound include other radiation curable compounds in addition to the above.

Examples of the other radiation curable compounds include (meth)acrylate (monofunctional (meth)acrylate and multifunctional (meth)acrylate), which is exemplified below.

Examples of the monofunctional (meth)acrylate include straight chain, branched, or cyclic alkyl(meth)acrylate, (meth)acrylate having a hydroxyl group, (meth)acrylate having a heterocycle, and (meth)acrylamide compounds.

Examples of the alkyl(meth)acrylate include methyl(meth)acrylate, ethyl(meth)acrylate, isobutyl(meth)acrylate, t-butyl(meth)acrylate, lauryl(meth)acrylate, stearyl(meth)acrylate, isostearyl(meth)acrylate, cyclohexyl(meth)acrylate, 4-t-cyclohexyl(meth)acrylate, isobornyl(meth)acrylate, and dicyclopentanyl(meth)acrylate.

Examples of the (meth)acrylate having a hydroxyl group include hydroxyethyl(meth)acrylate, hydroxypropyl(meth)acrylate, 4-hydroxybutyl(meth)acrylate, polyethylene glycol mono(meth)acrylate, methoxy polyethylene glycol mono(meth)acrylate, polypropylene glycol mono(meth)acrylate, methoxy polypropylene glycol mono(meth)acrylate, and mono(meth)acrylate of a block polymer of polyethylene glycol-polypropylene glycol.

Examples of the (meth)acrylate having a heterocycle include tetrahydrofurfuryl(meth)acrylate, 4-(meth)acryloyloxymethyl-2-methyl-2-ethyl-1,3-dioxolane, 4-(meth)acryloyloxymethyl-2-cyclohexyl-1,3-dioxolane, and adamantyl(meth)acrylate.

Examples of the (meth)acrylamide compound include (meth)acrylamide, N-methyl(meth)acrylamide, N-ethyl(meth)acrylamide, N-propyl(meth)acrylamide, N-butyl(meth)acrylamide, N,N′-dimethyl(meth)acrylamide, N,N′-diethyl(meth)acrylamide, N-hydroxyethyl(meth)acrylamide, N-hydroxypropyl(meth)acrylamide, and N-hydroxybutyl(meth)acrylamide.

Among the multifunctional (meth)acrylate, examples of bifunctional (meth)acrylate include 1,10-decanediol diacrylate, 2-methyl-1,8-octanediol diacrylate, 2-butyl-2-ethyl-1,3-propanediol diacrylate, 1,9-nonanediol diacrylate, 1,8-octanediol diacrylate, 1,7-heptanediol diacrylate, polytetramethylene glycol diacrylate, 3-methyl-1,5-pentanediol diacrylate, 1,6-hexanediol diacrylate, neopentyl glycol diacrylate, hydroxypivalic acid neopentyl glycol diacrylate, tripropylene glycol diacrylate, 1,4-butanediol diacrylate, dipropylene glycol diacrylate, 2-(2-vinyloxyethoxy)ethylacrylate, EO (ethylene oxide) modified bisphenol A diacrylate, PO (propylene oxide) modified bisphenol A diacrylate, EO modified hydrogenated bisphenol A diacrylate, and EO (ethylene oxide) modified bisphenol F diacrylate.

Among the multifunctional (meth)acrylate, examples of trifunctional or higher-functional (meth)acrylate include trimethylolpropane triacrylate, ethoxylated trimethylolpropane triacrylate, propoxylated trimethylolpropane triacrylate, pentaerythritol triacrylate, ethoxylated glycerin triacrylate, tetramethylol methane triacrylate, pentaerythritol tetraacrylate, ethoxylated pentaerythritol tetraacrylate, EO (ethylene oxide) modified diglycerin tetraacrylate, ditrimethylolpropanetetraacrylate modified acrylate, dipentaerythritol pentaacrylate, and dipentaerythritol hexaacrylate.

Content of Radiation Curable Compound

The content of the radiation curable compound is preferably from 50% by weight to 99% by weight, and more preferably from 70% by weight to 98% by weight with respect to a total amount of the model material.

In particular, regarding the radiation curable compound, it is preferable to use urethane(meth)acrylate and the other radiation curable compounds in combination. In this case, the content of the urethane(meth)acrylate is preferably from 10% by weight to 50% by weight, and more preferably from 15% by weight to 40% by weight with respect to a total amount of the model material. Meanwhile, the content of the other radiation curable compounds is preferably from 20% by weight to 70% by weight and more preferably from 30% by weight to 60% by weight with respect to a total amount of the model material.

In addition, the radiation curable compound may be used singly, or two or more kinds thereof may be used in combination.

Radiation Polymerization Initiator

Examples of the radiation polymerization initiator include well-known polymerization initiators such as a radiation radical polymerization initiator and a radiation cationic polymerization initiator.

Examples of the radiation radical polymerization initiator include aromatic ketones, an acyl phosphine oxide compound, an aromatic onium salt compound, organic peroxides, a thio compound (a thioxanthone compound, a compound containing a thiophenyl group, or the like), a hexaaryl biimidazole compound, a ketoxime ester compound, a borate compound, an azinium compound, a metallocene compound, an active ester compound, a compound having a carbon halogen bond, and an alkylamine compound.

The specific examples of the radiation radical polymerization initiator include well-known radiation polymerization initiators such as acetophenone, acetophenone benzyl ketal, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimothylketal, 1-(4-isopropylphenyl)-2-hydroxy-2-methylpropane-1-one, 2-hydroxy-2-methyl-1-phenylpropane-1-one, thioxanthone, diethylthioxanthone, 2-isopropylthioxanthone, 2-chlorothioxanthone, 2-methyl-1-[4-(methylthio)phenyl]-2-morpholino-propane-1-one, bis(2,4,6-trimethylbenzoyl)-phenyl phosphine oxide, 2,4,6-trimethylbenzoyl-diphenyl-phosphine oxide, 2,4-diethylthioxanthone, and bis-(2,6-dimethoxybenzoyl)-2,4,4-trimethyl pentyl phosphine oxide.

Content of Radiation Polymerization Initiator

The content of the radiation polymerization initiator is preferably, for example, from 1% by weight to 10% by weight, and more preferably from 3% by weight to 5% by weight with respect to the radiation curable compound.

In addition, the radiation polymerization initiator may be used singly, or two or more kinds thereof may be used in combination.

Polymerization Inhibitor

Examples of the polymerization inhibitor include well-known polymerization inhibitors such as a phenolic polymerization inhibitor (for example, p-methoxyphenol, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), 4,4′-thiobis(3-methyl-6-t-butylphenol), or the like), hindered amine, hydroquinone monomethyl ether (MEHQ), and hydroquinone.

Content of Polymerization Inhibitor

The content of the polymerization inhibitor is preferably, for example, from 0.1% by weight to 1% by weight, and more preferably from 0.3% by weight to 0.5% by weight with respect to the radiation curable compound.

In addition, the polymerization inhibitor may be used singly, or two or more kinds thereof may be used in combination.

Surfactant

Examples of the surfactant include well-known surfactants such as a silicone surfactant, an acrylic surfactant, a cationic surfactant, an anionic surfactant, a nonionic surfactant, an amphoteric surfactant, and a fluorine surfactant.

Content of Surfactant

The content of the surfactant is preferably, for example, from 0.05% by weight to 0.5% by weight, and more preferably from 0.1% by weight to 0.3% by weight with respect to the radiation curable compound.

In addition, the surfactant may be used singly, or two or more thereof may be used in combination.

Other Additives

In addition to the above, examples of the other additives include well-known additives such as a coloring material, a solvent, a sensitizer, a fixing agent, an antifungal agent, a preservative, an antioxidant, an ultraviolet ray absorbent, a chelating agent, a thickening agent, a dispersant, a polymerization promoter, a permeation promoter, and a humectant (moisturizing agent).

Properties of Model Material

The surface tension of the model material is, for example, in a range from 20 mN/m to 40 mN/m.

Here, the surface tension is a measured value using a Wilhelmy type surface tensiometer (manufactured by Kyowa Interface Science Co., LTD.), in an environment of 23° C. and 55% RH.

The viscosity of the model material is, for example, in a range from 30 mPa·s to 50 mPa·s.

Here, the viscosity is a measured value using a Rheomat 115 (manufactured by Contraves Co.) as a measuring apparatus, at a measuring temperature of 23° C. and a shear rate of 1400 s⁻¹.

Support Material

The three-dimension forming support material according to the exemplary embodiment (hereinafter, referred to as “support material”) contains the radiation curable compound and a plasticizer, in which the total concentration of the magnesium ion and the calcium ion is 50 ppm or less (preferably 45 ppm or less), the concentration of the alkali metal ion is 100 ppm or less (preferably 95 ppm or less), and the concentration of the fatty acid compound is 50 ppm or less (preferably 45 ppm or less). In addition, in the present specification, the concentration of each of the metal ion and the fatty acid compound is a concentration with respect to the entirety of the support material. In addition, ppm is based on a weight. The same applies to the following.

Even in the support material according to the exemplary embodiment, the total concentration of the magnesium ion and the calcium ion, the concentration of the alkali metal ion, and the total concentration of the fatty acid compound, which cause the formation of the sparingly soluble metal soap (fatty acid metal salt), are reduced within the aforementioned range. By doing this, in the support material, the formation of the sparingly soluble metal soap (fatty acid metal salt) is prevented and the precipitation of the metal soap as the granular substance on the surface of the three-dimensional structure is prevented. Thus, in the support material, in a discharge unit (for example, an inkjet head) for discharging the model material, discharge failures such as clogging of nozzles, reduction of a discharge amount, deviation of a discharge direction, or the like are prevented. Also, a situation where the foreign matter is captured by a filter within an apparatus, which causes clogging or blocking of the filter, and the discharge failures such as no-discharge are prevented.

Hereinafter, components of the support material according to the exemplary embodiment will be described in detail.

The support material according to the exemplary embodiment contains a radiation curable compound and a plasticizer. The support material may contain other additives such as a radiation polymerization initiator, a polymerization inhibitor, a surfactant, and a coloring material, in addition to the components described above.

In addition, the support material may use the components exemplified in the model material, in addition to the plasticizer. In addition, the properties of the support material are in the same range as the properties of the model material. Therefore, description of materials other than the plasticizer will be omitted.

Plasticizer

Examples of the plasticizer include water, and a non-radiation curable polymer. The non-radiation curable polymer is a polymer in which a curing (polymerization) reaction does not occur by radiation (for example, an ultraviolet ray or an electron beam).

As the non-radiation curable polymer, at least one type selected from the group consisting of polyether polyol, castor oil polyol, and polyester polyol, is preferable.

Polyether Polyol

Examples of the polyether polyol include a multimer of polyol, adducts of polyol and alkylene oxide, and a ring opening polymer of alkylene oxide.

Examples of the polyol include ethylene glycol, diethylene glycol, propylene glycol, dipropylene glycol, 1,4-butanediol, 1,3-butanediol, neopentyl glycol, 1,6-hexanediol, 1,2-hexanediol, 3-methyl-1,5-pentanediol, 2-butyl-2-ethyl-1,3-propanediol, 2,4-diethyl-1,5-pentanediol, 1,8-octanediol, 1,9-nonanediol, 2-methyl-1,8-octanediol, 1,8-decanediol, octadecanediol, glycerin, trimethylolpropane, pentaerythritol, and hexanetriol.

Examples of the alkylene oxide include ethylene oxide, propylene oxide, butylene oxide, styrene oxide, epichlorohydrin, and tetrahydrofuran.

Castor Oil Polyol

Examples of the castor oil polyol include a modified castor oil in which castor oil is modified with polyol, and a modified castor oil fatty acid in which a castor oil fatty acid (a fatty acid obtained from the castor oil) is modified with polyol.

Examples of the polyol include polyol exemplified in the description of the polyether polyol.

Polyester Polyol

Examples of the polyester polyol include reaction products of polyol and dibasic acid, and a ring opening polymer of a cyclic ester compound.

Here, examples of the polyol include polyols exemplified in the description of the polyether polyol.

Examples of the dibasic acid include a carboxylic acid (for example, succinic acid, adipic acid, sebacic acid, a dimer acid, maleic acid, phthalic acid, isophthalic acid, and terephthalic acid), and anhydrides of the carboxylic acid.

Examples of the cyclic ester compound include ε-caprolactone and β-methyl-δ-valerolactone.

Here, as the non-radiation curable polymer, the various polyols described above and the polyol may be used in combination. In particular, the polyol is preferably used in combination with the polyester polyol. That is, as the non-radiation curable polymer, a mixture of the polyester polyol and the polyol may be exemplified.

The content of the polyol to be used in combination with the various polyols described above is preferably from 30% by weight to 60% by weight (more preferably from 35% by weight to 50% by weight) with respect to entire radiation curable polymers. In particular, in a case where the mixture of the polyester polyol and the polyol is used, the weight ratio (polyester polyol/polyol) is preferably from 30/70 to 10/90 (more preferably from 25/75 to 20/80).

In addition, examples of the polyol include polyol exemplified in the description of polyether polyol.

Weight average molecular weight of non-radiation curable polymer

The weight average molecular weight of the non-radiation curable polymer is preferably from 200 to 1000, and more preferably from 250 to 850.

The weight average molecular weight of the non-radiation curable polymer is a value measured by gel permeation chromatography (GPC) using polystyrene as a reference substance.

Content of Plasticizer

The content of the plasticizer is preferably, for example, from 25% by weight to 60% by weight, more preferably from 30% by weight to 50% by weight, and even more preferably from 35% by weight to 50% by weight with respect to a total amount of the support material.

In addition, the non-radiation curable polymer may be used singly, or two or more kinds thereof may be used in combination.

Here, since the support material contains a plasticizer, the content of the radiation curable compound is preferably from 10% by weight to 90% by weight, and more preferably from 20% by weight to 80% by weight with respect to a total amount of the support material.

In particular, in the support material, similarly to the model material, it is preferable to use the urethane(meth)acrylate and the other radiation curable compounds in combination as the radiation curable compound. In this case, the content of the urethane(meth)acrylate is preferably from 1% by weight to 30% by weight, and more preferably from 5% by weight to 20% by weight with respect to a total amount of the support material. Meanwhile, the content of the other radiation curable compound described above is preferably from 10% by weight to 50% by weight, and more preferably from 15% by weight to 45% by weight with respect to a total amount of the support material.

Three-dimension forming composition set

The three-dimension forming composition set according to the exemplary embodiment has the model material (three-dimension forming material) containing a radiation curable compound and the support material (three-dimension forming support material) containing a radiation curable compound and a plasticizer. In addition, the model material according to the exemplary embodiment is applied to the model material for the three-dimension forming composition set. In addition, from a viewpoint of preventing the discharge failures, the support material according to the exemplary embodiment is preferably applied to the support material for the three-dimension forming composition set.

Three-dimension forming apparatus/Method for preparing a three-dimensional structure

The three-dimension forming apparatus according to the exemplary embodiment includes a first discharge unit having the model material (three-dimension forming material) accommodated therein and discharging the model material, a second discharge unit having the support material (three-dimension forming support material) accommodated therein and discharging the support material, and a radiation irradiation unit applying radiation that cures the discharged model material and the support material. In addition, the model material according to the exemplary embodiment is applied to the model material. In addition, from a viewpoint of preventing the discharge failures, the support material according to the exemplary embodiment is preferably applied to the support material.

In the three-dimension forming apparatus according to the exemplary embodiment, a method for preparing a three-dimensional structure (the method for preparing a three-dimensional structure according to the exemplary embodiment) including: discharging the model material (three-dimension forming material) among the three-dimension forming composition set according to the exemplary embodiment and curing the model material by radiation irradiation to form a structure; and discharging the support material (three-dimension forming support material) among the three-dimension forming composition set according to the exemplary embodiment and curing the support material by radiation irradiation to forma support portion for supporting at least apart of the structure, is carried out. In addition, in the method for preparing a three-dimensional structure according to the exemplary embodiment, the three-dimensional structure is prepared by removing the support portion after forming the structure.

In addition, the three-dimension forming apparatus according to the exemplary embodiment may include a model material cartridge (three-dimension forming material cartridge), which is configured as a cartridge so as to accommodate the model material and be detachable from the three-dimension forming apparatus. In addition, in the same manner, the three-dimension forming apparatus may include a support material cartridge (three-dimension forming support material cartridge), which is configured as a cartridge so as to accommodate the support material and be detachable from the three-dimension forming apparatus.

Hereinafter, the three-dimension forming apparatus according to the exemplary embodiment will be described with reference to the drawings.

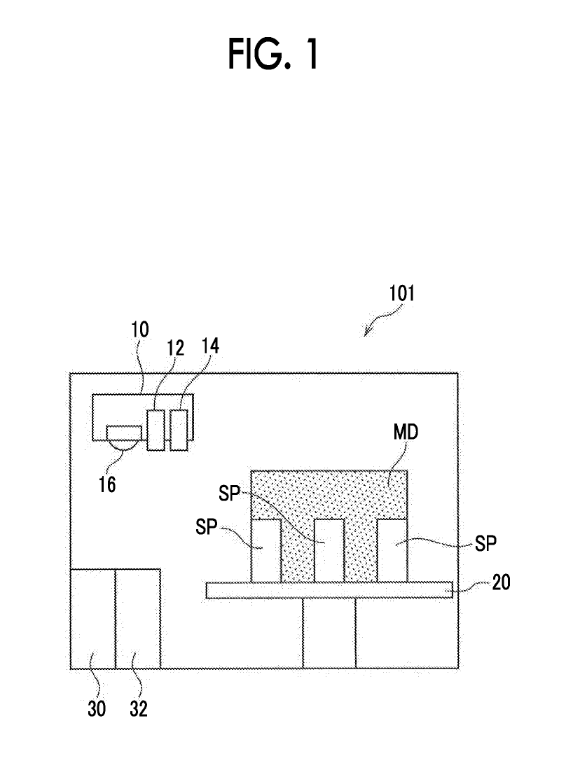

FIG. 1 is a configuration diagram schematically illustrating one example of a three-dimension forming apparatus according to the exemplary embodiment.

A three-dimension forming apparatus 101 according to the exemplary embodiment is an ink jet type three-dimension forming apparatus. As illustrated in FIG. 1, the three-dimension forming apparatus 101 includes, for example, a forming unit 10 and a forming board 20. In addition, the three-dimension forming apparatus 101 includes a model material cartridge 30 having the model material accommodated therein and a support material cartridge 32 having the support material accommodated therein such that the cartridges are detachable from the apparatus. In addition, in FIG. 1, MD indicates a structure and SP indicates a support portion.

The forming unit 10 includes, for example, a model material discharge head 12 (one example of the first discharge unit) for discharging a droplet of the model material, a support material discharge head 14 (one example of the second discharge unit) for discharging a droplet of the support material, and a radiation irradiation device 16 (radiation irradiation device) applying radiation. In addition to the above, the forming unit 10 may include (not illustrated), for example, a rotation roller for removing excess model material and the support material from the model material and the support material discharged on the forming board 20 and flattening the materials.

The forming unit 10 is configured, for example, to be movable over a forming region of the forming board 20 by a driving unit (not illustrated) in a main scanning direction and in a sub-scanning direction intersecting with (for example, perpendicular to) the main scanning direction (so-called a carriage type).

As for the respective model material discharge head 12 and the support material discharge head 14, a piezo type (piezoelectric type) discharge head for discharging droplets of each material by pressure is adopted. Each of the discharge heads is not limited thereto, and the head may be a discharge head for discharging each material by pressure from a pump.

The model material discharge head 12 is, for example, connected to the model material cartridge 30 through a supply line (not illustrated). In addition, the model material is supplied to the model material discharge head 12 from the model material cartridge 30.

The support material discharge head 14 is, for example, connected to the support material cartridge 32 through a supply line (not illustrated). In addition, the support material is supplied to the support material discharge head 14 from the support material cartridge 32.

Each of the model material discharge head 12 and the support material discharge head 14 is short-length discharge head configured to have an effective discharge region (arrangement region of the nozzles discharging the model material and the support material) smaller than the forming region of the forming board 20.

In addition, each of the model material discharge head 12 and the support material discharge head 14 may be an elongated head, for example, configured to have an effective discharge region (arrangement region of the nozzles discharging the model material and the support material) larger than the width of the forming region (length in a direction intersecting with (for example, perpendicular to) the moving direction (main scanning direction) of the forming unit 10) on the forming board 20. In this case, the forming unit 10 is configured to move only in the main scanning direction.

The radiation irradiation device 16 is selected depending on the type of the model material and the support material. Examples of the radiation irradiation device 16 include an ultraviolet ray irradiation device and an electron beam irradiation device.

Here, examples of the ultraviolet ray irradiation device to be applied include devices having a light source, such as a metal halide lamp, a high pressure mercury lamp, an ultrahigh pressure mercury lamp, a deep ultraviolet ray lamp, a lamp to excite a mercury lamp without electrodes from the outside using microwaves, an ultraviolet ray laser, a xenon lamp, and UV-LED.

Examples of the electron beam irradiation device include a scanning type electron beam irradiation device, a curtain type electron beam irradiation device, and a plasma discharge type electron beam irradiation device.

The forming board 20 has a surface having a forming region where a structure is formed by the model material and the support material being discharged. In addition, the forming board 20 is configured to be vertically movable by the driving unit (not illustrated).

Next, an operation of the three-dimension forming apparatus 101 according to the exemplary embodiment (method for preparing a three-dimensional structure) will be described.

First, through a computer (not illustrated), as data for three-dimension formation, for example, two-dimensional shape data (slice data) for forming a structure are created from, for example, three-dimensional Computer Aided Design (CAD) data of the three-dimensional structure formed by the model material. At this time, the two-dimensional shape data (slice data) for forming a support portion using the support material is also created. The two-dimensional shape data for forming a support portion is configured such that, in a case where the width of an upper structure is greater than the width of a lower structure, in other words, when there is an overhanging portion, the support portion is formed to support the overhanging portion from below.

Next, based on the two-dimensional shape data for forming a structure, the model material is discharged from the model material discharge head 12 while moving the forming unit 10, so as to form a layer of the model material on the forming board 20. Then, the layer of the model material is irradiated with radiation by the radiation irradiation device 16 to cure the model material, thereby forming a layer to be a part of the structure.

If necessary, based on the two-dimensional shape data for forming a support portion, the support material is discharged from the support material discharge head 14 while moving the forming unit 10, so as to form a layer of the support material adjacent to the layer of the model material on the forming board 20. Then, the layer of the support material is irradiated with radiation by the radiation irradiation device 16 to cure the support material, thereby forming a layer to be a part of the support portion.

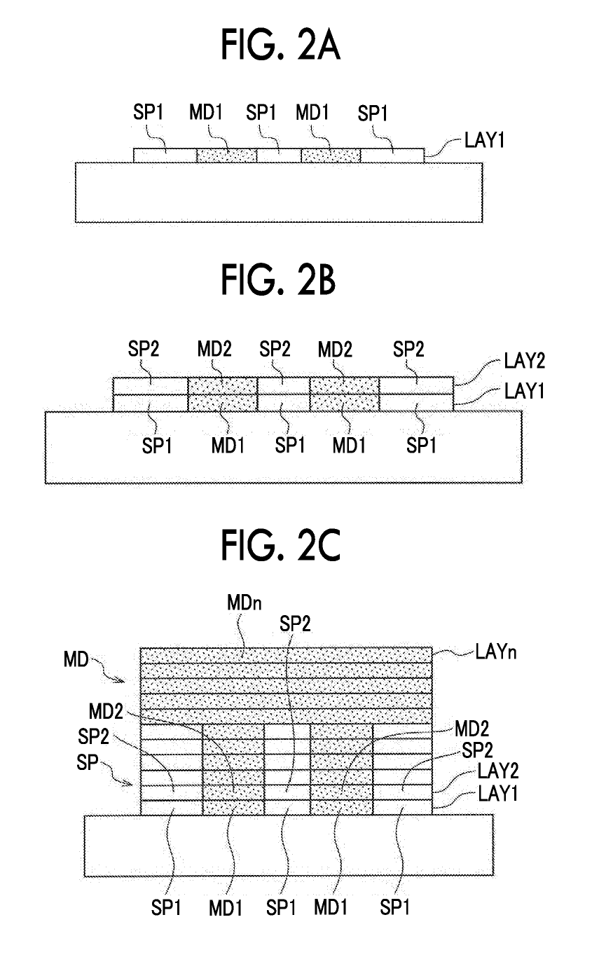

In this way, a first layer LAY1 including the layer to be a part of the structure and, if necessary, the layer to be a part of the support portion is formed (refer to FIG. 2A). Here, in FIG. 2A, MD1 indicates the layer to be a part of the structure in the first layer LAY1, and SP1 indicates the layer to be a part of the support portion in the first layer LAY1.

Next, the forming board 20 is moved downward. Due to the downward move of the forming board 20, the thickness of a second layer to be formed next (the second layer including the layer to be a part of the structure and, if necessary, the layer to be a part of the support portion), is set.

Next, in the same manner as the first layer LAY1, a second layer LAY2, including the layer to be a part of the structure and, if necessary, the layer to be apart of the support portion, is formed (refer to FIG. 2B). Here, in FIG. 2B, MD2 indicates the layer to be a part of the structure in the second layer LAY2, and SP2 indicates the layer to be a part of the support portion in the second layer LAY2.

In addition, operations for forming the first layer LAY1 and the second layer LAY2 are carried out repeatedly to form layers up to the n^{th} layer LAYn. In this case, a structure, at least a part of which is supported by the support portion, is formed (refer to FIG. 2C). Here, in FIG. 2C, MDn indicates a layer to be a part of the structure in the n^{th} layer LAYn. MD indicates the structure. SP indicates the support portion.

After that, when the support portion is removed from the structure, a desired structure is obtained. Here, as the method of removing the support portion, for example, a method of removing the portion by hands (break away method), or a method of removal by spraying gas or liquid, is adopted.

In addition, the obtained structure may be subjected to post-treatment such as polishing.

### Examples

Hereinafter, the invention will be described in detail based on Examples, but the invention is not limited to Examples described below. In addition, “parts” refer to “parts by weight” unless otherwise specifically indicated.

Preparation/Storage of Model Material and Support Material

According to the compositions and preparation methods shown in Tables 4 to 6, respective model materials and support materials are prepared, and then the respective model materials and support materials are stored according to the storage method shown in Tables 4 to 6.

Hereinafter, as for the preparation method applied, Preparation Examples 1 and 2 are shown, and as for the storage method applied, Storage Examples 1 to 4 are shown. In addition, the composition of the model material to be used is shown in Table 1. The composition of the support material to be used is shown in Table 2. In addition, the concentration of the metal ion in each composition is shown in Table 3.

In addition, respective model materials 12 to 16, 20 to 24, and 28 to 32, and respective support materials 3 to 8 correspond to Examples, and model materials 1 to 11, 17 to 19, 25 to 27, and 33 to 48, and support materials 1 and 2 and 9 to 12 correspond to Comparative Examples.

### Preparation Example 1

In Preparation Example 1, the respective model materials and support materials are all prepared by using glass equipment, equipment subjected to glass lining, and equipment made of TEFLON (registered trademark).

Specifically, in an environment where the ultraviolet ray is blocked (cut), after a coloring material, which is a processed pigment, and a polymerization inhibitor are added to a dark brown light-shielded glass container with a monomer therein and mixed by being stirred sufficiently, and then the pigment is dispersed by ultrasonic wave dispersion. Next, an oligomer and a surfactant are added to the light-shielded glass container and mixed by stirring sufficiently to dissolve the contents. A polymerization initiator is added to the obtained mixed liquid and mixed by stirring sufficiently to dissolve the contents. Next, the obtained mixed liquid is filtered by a membrane filter made of hydrophilized polytetrafluoroethylene (PTFE) having a pore size of 5 μm. The respective model materials and support materials are obtained through these processes.

In addition, the concentration of the detected fatty acid compound (stearic acid and derivatives thereof) in a case where the same operation is carried out using n-hexane is equal to or less than the detection limit.

### Preparation Example 2

In Preparation Example 2, respective model materials and support materials are all prepared by using disposable plastic equipments (equipment made of polyethylene, equipment made of polypropylene, and equipment made of Teflon).

Specifically, in an environment where the ultraviolet ray is blocked (cut), after a coloring material, which is a processed pigment, and a polymerization inhibitor are added to a milky white polypropylene container with a monomer therein and mixed by being stirred sufficiently, and then the pigment is dispersed by ultrasonic wave dispersion. Next, an oligomer and a surfactant are added to the polypropylene container and mixed by stirring sufficiently to dissolve the contents. A polymerization initiator is added to the obtained mixed liquid and mixed by stirring sufficiently to dissolve the contents. Next, the obtained mixed liquid is filtered by a membrane filter made of hydrophilized PTFE having a pore size of 5 μm. The respective model materials and support materials are obtained through these processes.

In addition, the concentration of the detected fatty acid compound (stearic acid and derivatives thereof) in a case where the same operation is carried out using n-hexane is 730 ppm.

### Storage Example 1

In Storage Example 1, the model materials and support materials in an aluminum-laminated plastic bag are stored in a cool and dark place for 3 months.

The structure of the bag is a standing pouch type bag in which, in order from the outermost layer, a polyethylene terephthalate (PET) film having a thickness of 12 μm, an aluminum foil having a thickness of 9 μm, a biaxially stretched nylon film having a thickness of 15 μm, and a cast polypropylene film having a thickness of 80 μm are attached to each other by dry laminate.

In addition, the concentration of the fatty acid compound (stearic acid and derivatives thereof) in n-hexane in a case where the inside of the bag is washed using 100 ml of n-hexane is 300 ppm.

### Storage Example 2

In Storage Example 2, the respective model materials and support materials in a brown wide-mouthed round light-shielded bottle (made of HDPE) manufactured by AS ONE Corporation are stored in a cool and dark place for 3 months.

In addition, the concentration of the fatty acid compound (stearic acid and derivatives thereof) in n-hexane in a case where the inside of the bottle is washed using 100 ml of n-hexane is 212 ppm.

### Storage Example 3

In Storage Example 3, the respective model materials and support materials in a brown bottle (bottle made of hard glass) manufactured by AS ONE Corporation are stored in a cool and dark place for 3 months.

In addition, the concentration of the fatty acid compound (stearic acid and derivatives thereof) in n-hexane in a case where the inside of the bottle is washed using 100 ml of n-hexane is equal to or less than the detection limit.

### Storage Example 4

In Storage Example 4, after the inside of the aluminum-laminated plastic bag used in Storage Example 1 is washed with 100 ml of n-hexane and dried sufficiently, the bag is made to be filled with the respective model materials and support materials and stored in a cool and dark place for 3 months.

In addition, after the bag is washed, the dried inside thereof is made to be filled with 100 ml of n-hexane, and the bag is stored for 3 months, and thereafter, the concentration of the fatty acid compound (stearic acid and derivatives thereof) is 43 ppm.

Forming Apparatus

In order to perform respective tests, the following forming apparatus for a test is prepared.

The Polaris head (model number PQ512/85) manufactured by Fujifilm Dimatix Inc. is selected as an ink jet head, Subzero-055 (intensity: 100 w/cm) manufactured by INTEGRATION TECHNOLOGY LTD is selected as an irradiation light source of the ultraviolet ray, and these are provided in a forming apparatus including a driving unit and a controlling unit to configure a forming apparatus for a test.

In addition, in the forming apparatus, the inkjet head is reciprocally driven along with the light source, and lamination of the model material layer or the support material layer each having a thickness of 20 μm and curing process by irradiation with the ultraviolet ray are performed for one scanning to form a structure.

In addition, in the forming apparatus, the model material and the support material are made to go through a chemical-resistant tube Tygon 2375 manufactured by Saint-Gobain K.K. from a storage tank by a liquid feeding pump under the light-shielded condition, pass through a profile star A050 filter (filtering accuracy of 5 μm) manufactured by Pall Corporation to remove the foreign matter, and be fed to an ink jet head.

Filter Test 1

The following filter test 1 is carried out using the model material and the support material (model material and support material after storage). The results are shown in Tables 4 to 6.

The filter test 1 is carried out such that a pressure gauge is disposed immediately before a filter of the forming apparatus and the total 3 L of each of the model material and the support material is made to pass through a filter. Evaluation is performed such that a case where the pressure shows 0.5 MPa or more (maximum working pressure is 0.65 MPa) is rated as “NG”, a case where the pressure shows equal to or more than 0.1 MPa to less than 0.5 MPa is rated as “G2”, and a case where the pressure shows less than 0.1 MPa is rated as “G1”.

Discharge Stability Test

The following discharge stability test is carried out using the model material and the support material (model material and support material after storage). The results are shown in Tables 4 to 6.

The discharge stability test is carried out using the model material and the support material as a set, in which a cube having a size of 30 mm×30 mm×30 mm is formed by the model material on an aluminum substrate having a size of 100 mm×100 mm and the surrounding thereof is supported by the support portion including the support material.

In addition, at this time, a case where no-discharge occurs in the 3 or more nozzles is rated as “NG”, a case where no-discharge occurs in the 1 to 2 nozzles is rated as “G2”, and a case where discharging occurs in all of the nozzles is rated as “G1”. Also, the discharge stability test is not carried out with respect to cases where the result of the filter test is “NG”.

TABLE 1

| | | | Model | Model | Model | Model | Model | Model | Model | Model |
|---|---|---|---|---|---|---|---|---|---|---|
| | | | material | material | material | material | material | material | material | material |
| | | | compo- | compo- | compo- | compo- | compo- | compo- | compo- | compo- |
| | | | sition 1 | sition 2 | sition 3 | sition 4 | sition 5 | sition 6 | sition 7 | sition 8 |
| Coloring | Microlith | Manufactured | 1.1 | | | | | | 0.7 | |
| material | Yellow 1061K | by BASF Japan Ltd. | | | | | | | | |
| | Microlith | Manufactured | | 1.0 | | | | | | 0.4 |
| | Magenta 4535 K | by BASF Japan Ltd. | | | | | | | | |
| | Microlith | Manufactured | | | | | 0.7 | | | 0.3 |
| | Magenta 4500 J | by BASF Japan Ltd. | | | | | | | | |
| | Microlith | Manufactured | | | 1.0 | | | | | |
| | Blue 7080 K | by BASF Japan Ltd. | | | | | | | | |
| | Microlith | Manufactured | | | | 1.0 | | | | |
| | Black 0066 K | by BASF Japan Ltd. | | | | | | | | |
| Urethane | U-15HA | Manufactured | 20.0 | 20.0 | 20.0 | 20.0 | 20.0 | 20.0 | 20.0 | 20.0 |
| oligomer | | by SHIN-NAKAMURA | | | | | | | | |
| | | CHEMICAL | | | | | | | | |
| | | CO., LTD. | | | | | | | | |
| | UA-4200 | Manufactured | 18.0 | 18.0 | 18.0 | 18.0 | 18.0 | 18.0 | 18.0 | 18.0 |
| | | by SHIN-NAKAMURA | | | | | | | | |
| | | CHEMICAL | | | | | | | | |
| | | CO., LTD. | | | | | | | | |
| Monomer | APG-100 | Manufactured | 39.2 | 39.3 | 39.3 | 39.3 | 39.6 | 40.3 | 39.6 | 39.6 |
| | (dipropylene | by SHIN-NAKAMURA | | | | | | | | |
| | glycol | CHEMICAL | | | | | | | | |
| | diacrylate) | CO., LTD. | | | | | | | | |
| | Isobornyl acrylate | Manufactured | 20.0 | 20.0 | 20.0 | 20.0 | 20.0 | 20.0 | 20.0 | 20.0 |
| | | by OSAKA ORGANIC | | | | | | | | |
| | | CHEMICAL | | | | | | | | |
| | | INDUSTRY LTD. | | | | | | | | |
| Polymerization | Irgacure TPO | Manufactured | 0.4 | 0.4 | 0.4 | 0.4 | 0.4 | 0.4 | 0.4 | 0.4 |
| initiator | | by BASF Japan Ltd. | | | | | | | | |
| | Irgacure 1173 | Manufactured | 0.6 | 0.6 | 0.6 | 0.6 | 0.6 | 0.6 | 0.6 | 0.6 |
| | | by BASF Japan Ltd. | | | | | | | | |
| Polymerization | 4-methoxyphenol | Manufactured | 0.5 | 0.5 | 0.5 | 0.5 | 0.5 | 0.5 | 0.5 | 0.5 |
| inhibitor | | by Tokyo Chemical | | | | | | | | |
| | | Industry Co., Ltd. | | | | | | | | |
| Surfactant | TEGORAD 2100 | Manufactured | 0.2 | 0.2 | 0.2 | 0.2 | 0.2 | 0.2 | 0.2 | 0.2 |
| | | by Evonik | | | | | | | | |
| | | Industries AG | | | | | | | | |

TABLE 2

| | | | Support | Support |
|---|---|---|---|---|
| | | | material | material |
| | | | composition 3 | composition 4 |
| Coloring | Microlith Blue 7080 K | Manufactured by BASF Japan Ltd. | | 0.2 |
| material | | | | |
| Oligomer | Alpha resin UV-5000-I | Manufactured by Alpha Kaken Co., Ltd. | 20.0 | 20.0 |
| | ME-3 (methoxy triethylene | Manufactured by DKS Co. Ltd. | 28.5 | 28.3 |
| | glycol acrylate) | | | |
| | PE-400 (polyethylene | Manufactured by DKS Co. Ltd. | 25.0 | 25.0 |
| | glycol 400 diacrylate) | | | |
| Monomer | Diacetone acrylamide | Manufactured by Nippon Kasei Chemical | 10.0 | 10.0 |
| | | Co., Ltd. | | |
| Polymerization | Irgacure TPO | Manufactured by BASF Japan Ltd. | 3.0 | 3.0 |
| initiator | Irgacure 379 | Manufactured by BASF Japan Ltd. | 1.0 | 1.0 |
| | 4-isopropyl thioxanthone | Manufactured by Tokyo Chemical Industry | 1.0 | 1.0 |
| | | Co., Ltd. | | |
| Polymerization | 4-methoxyphenol | Manufactured by Tokyo Chemical Industry | 0.5 | 0.5 |
| inhibitor | | Co., Ltd. | | |
| Surfactant | TEGO WET 270 | Manufactured by Evonik Industries AG | 1.0 | 1.0 |
| Plasticizer | Ion exchanged water | — | 10.0 | 10.0 |

TABLE 3

| | Metal ion concentration | | | | | |
|---|---|---|---|---|---|---|
| | Na+ | K+ | Mg2+ | Ca2+ | Total of alkali metal ion | Total of Mg2+ & Ca2+ |
| | (ppm) | (ppm) | (ppm) | (ppm) | (ppm) | (ppm) |
| Model material composition 1 | 51 | 89 | 9.3 | 13.1 | 140 | 22.4 |
| Model material composition 2 | 22 | 29 | 49 | 50 | 51 | 99 |
| Model material composition 3 | 68 | 34 | 7.1 | 14.3 | 102 | 21.4 |
| Model material composition 4 | 45 | 20 | 18 | 25 | 65 | 43 |
| Model material composition 5 | 7.1 | 8.3 | 17 | 22 | 15.4 | 39 |
| Model material composition 6 | 0.07 | <0.03 | 0.009 | 0.003 | 0.07 | 0.012 |
| Model material composition 7 | 33 | 58 | 6.0 | 8.3 | 91 | 14.3 |
| Model material composition 8 | 47 | 29 | 18 | 23 | 76 | 41 |
| Support material composition 1 | 0.10 | <0.03 | 0.011 | 0.004 | 0.10 | 0.015 |
| Support material composition 2 | 13 | 8 | 11 | 9 | 21 | 20 |

TABLE 4

| | | | | | | Total | | Concentration |
|---|---|---|---|---|---|---|---|---|
| | | | | | | concentration | Total | of fatty |
| | | | | | | of | concentration | acid |
| | | | | Filter | Discharge | alkali metal | of Mg2+ & | compound |
| | Composition | Preparation method | Storage method | test 1 | stability | ion (ppm) | Ca2+ (ppm) | (ppm) |
| Model | Model material | Preparation Example 1 | Storage Example 1 | NG | — | 140 | 22.4 | 300 |
| material 1 | composition 1 | | | | | | | |
| Model | Model material | Preparation Example 1 | Storage Example 1 | NG | — | 51 | 99 | 300 |
| material 2 | composition 2 | | | | | | | |
| Model | Model material | Preparation Example 1 | Storage Example 1 | NG | — | 102 | 21.4 | 300 |
| material 3 | composition 3 | | | | | | | |
| Model | Model material | Preparation Example 1 | Storage Example 1 | G2 | NG | 65 | 43 | 300 |
| material 4 | composition 4 | | | | | | | |
| Model | Model material | Preparation Example 1 | Storage Example 1 | G2 | NG | 15.4 | 39 | 300 |
| material 5 | composition 5 | | | | | | | |
| Model | Model material | Preparation Example 1 | Storage Example 1 | G2 | NG | 0.07 | 0.012 | 300 |
| material 6 | composition 6 | | | | | | | |
| Model | Model material | Preparation Example 1 | Storage Example 1 | G2 | NG | 91 | 14.3 | 300 |
| material 7 | composition 7 | | | | | | | |
| Model | Model material | Preparation Example 1 | Storage Example 1 | G2 | NG | 76 | 41 | 300 |
| material 8 | composition 8 | | | | | | | |
| Support | Support material | Preparation Example 1 | Storage Example 1 | G2 | NG | 0.10 | 0.015 | 300 |
| material 1 | composition 1 | | | | | | | |
| Support | Support material | Preparation Example 1 | Storage Example 1 | G2 | NG | 21 | 20 | 300 |
| material 2 | composition 2 | | | | | | | |
| Model | Model material | Preparation Example 1 | Storage Example 2 | NG | — | 140 | 22.4 | 121 |
| material 9 | composition 1 | | | | | | | |
| Model | Model material | Preparation Example 1 | Storage Example 2 | NG | — | 51 | 99 | 121 |
| material 10 | composition 2 | | | | | | | |
| Model | Model material | Preparation Example 1 | Storage Example 2 | NG | — | 102 | 21.4 | 121 |
| material 11 | composition 3 | | | | | | | |
| Model | Model material | Preparation Example 1 | Storage Example 2 | G2 | NG | 65 | 43 | 121 |
| material 12 | composition 4 | | | | | | | |
| Model | Model material | Preparation Example 1 | Storage Example 2 | G2 | NG | 15.4 | 39 | 121 |
| material 13 | composition 5 | | | | | | | |
| Model | Model materialX | Preparation Example 1 | Storage Example 2 | G2 | NG | 0.07 | 0.012 | 121 |
| material 14 | composition 5 | | | | | | | |
| Model | Model material | Preparation Example 1 | Storage Example 2 | G2 | NG | 91 | 14.3 | 121 |
| material 15 | composition 7 | | | | | | | |
| Model | Model material | Preparation Example 1 | Storage Example 2 | G2 | NG | 76 | 41 | 121 |
| material 16 | composition 8 | | | | | | | |
| Support | Support material | Preparation Example 1 | Storage Example 2 | G2 | NG | 0.10 | 0.015 | 121 |
| material 3 | composition 1 | | | | | | | |
| Support | Support material | Preparation Example 1 | Storage Example 2 | G2 | NG | 21 | 20 | 121 |
| material 4 | composition 2 | | | | | | | |

TABLE 5

| | | | | | | Total | Total | Concentration |
|---|---|---|---|---|---|---|---|---|
| | | | | | | concentration | concentration | of fatty |
| | | | | | | of alkali | of Mg2+ & | acid |
| | | | | Filter | Discharge | metal ion | Ca2+ | compound |
| | Composition | Preparation method | Storage method | test 1 | stability | (ppm) | (ppm) | (ppm) |
| Model | Model material | Preparation Example 1 | Storage Example 3 | NG | — | 140 | 22.4 | 0 |
| material 17 | composition 1 | | | | | | | |
| Model | Model material | Preparation Example 1 | Storage Example 3 | NG | — | 51 | 99 | 0 |
| material 18 | composition 2 | | | | | | | |
| Model | Model material | Preparation Example 1 | Storage Example 3 | NG | — | 102 | 21.4 | 0 |
| material 19 | composition 3 | | | | | | | |
| Model | Model material | Preparation Example 1 | Storage Example 3 | G1 | G2 | 65 | 43 | 0 |
| material 20 | composition 4 | | | | | | | |
| Model | Model material | Preparation Example 1 | Storage Example 3 | G1 | G2 | 15.4 | 39 | 0 |
| material 21 | composition 5 | | | | | | | |
| Model | Model material | Preparation Example 1 | Storage Example 3 | G1 | G1 | 0.07 | 0.012 | 0 |
| material 22 | composition 6 | | | | | | | |
| Model | Model material | Preparation Example 1 | Storage Example 3 | G1 | G1 | 91 | 14.3 | 0 |
| material 23 | composition 7 | | | | | | | |
| Model | Model material | Preparation Example 1 | Storage Example 3 | G1 | G2 | 76 | 41 | 0 |
| material 24 | composition 8 | | | | | | | |
| Support | Support material | Preparation Example 1 | Storage Example 3 | G1 | G1 | 0.10 | 0.015 | 0 |
| material 5 | composition 1 | | | | | | | |
| Support | Support material | Preparation Example 1 | Storage Example 3 | G1 | G1 | 21 | 20 | 0 |
| material 6 | composition 2 | | | | | | | |
| Model | Model material | Preparation Example 1 | Storage Example 4 | NG | — | 140 | 22.4 | 43 |
| material 25 | composition 1 | | | | | | | |
| Model | Model material | Preparation Example 1 | Storage Example 4 | NG | — | 51 | 99 | 43 |
| material 26 | composition 2 | | | | | | | |
| Model | Model material | Preparation Example 1 | Storage Example 4 | NG | — | 102 | 21.4 | 43 |
| material 27 | composition 3 | | | | | | | |
| Model | Model material | Preparation Example 1 | Storage Example 4 | G1 | G2 | 65 | 43 | 43 |
| material 28 | composition 4 | | | | | | | |
| Model | Model material | Preparation Example 1 | Storage Example 4 | G1 | G2 | 15.4 | 39 | 43 |
| material 29 | composition 5 | | | | | | | |
| Model | Model material | Preparation Example 1 | Storage Example 4 | G1 | G1 | 0.07 | 0.012 | 43 |
| material 30 | composition 6 | | | | | | | |
| Model | Model material | Preparation Example 1 | Storage Example 4 | G1 | G1 | 91 | 14.3 | 43 |
| material 31 | composition 7 | | | | | | | |
| Model | Model material | Preparation Example 1 | Storage Example 4 | G1 | G2 | 76 | 41 | 43 |
| material 32 | composition 8 | | | | | | | |
| Support | Support material | Preparation Example 1 | Storage Example 4 | G1 | G1 | 0.10 | 0.015 | 43 |
| material 7 | composition 1 | | | | | | | |
| Support | Support material | Preparation Example 1 | Storage Example 4 | G1 | G2 | 21 | 20 | 43 |
| material 8 | composition 2 | | | | | | | |

TABLE 6

| | | | | | | Total | | Concentration |
|---|---|---|---|---|---|---|---|---|
| | | | | | | concentration | Total | of fatty |
| | | | | | | of alkali | concentration | acid |
| | | | | Filter | Discharge | metal | of Mg2+ & | compound |
| | Composition | Preparation method | Storage method | test 1 | stability | ion (ppm) | Ca2+ (ppm) | (ppm) |
| Model | Model material | Preparation Example 2 | Storage Example 3 | NG | — | 140 | 22.4 | 730 |
| material 33 | composition 1 | | | | | | | |
| Model | Model material | Preparation Example 2 | Storage Example 3 | NG | — | 51 | 99 | 730 |
| material 34 | composition 2 | | | | | | | |
| Model | Model material | Preparation Example 2 | Storage Example 3 | NG | — | 102 | 21.4 | 730 |
| material 35 | composition 3 | | | | | | | |
| Model | Model material | Preparation Example 2 | Storage Example 3 | NG | — | 65 | 43 | 730 |
| material 36 | composition 4 | | | | | | | |
| Model | Model material | Preparation Example 2 | Storage Example 3 | NG | — | 15.4 | 39 | 730 |
| material 37 | composition 5 | | | | | | | |
| Model | Model material | Preparation Example 2 | Storage Example 3 | NG | — | 0.07 | 0.012 | 730 |
| material 38 | composition 6 | | | | | | | |
| Model | Model material | Preparation Example 2 | Storage Example 3 | NG | — | 91 | 14.3 | 730 |
| material 39 | composition 7 | | | | | | | |
| Model | Model material | Preparation Example 2 | Storage Example 3 | NG | — | 76 | 41 | 730 |
| material 40 | composition 8 | | | | | | | |
| Support | Support material | Preparation Example 2 | Storage Example 3 | NG | — | 0.10 | 0.015 | 730 |
| material 9 | composition 1 | | | | | | | |
| Support | Support material | Preparation Example 2 | Storage Example 3 | NG | — | 21 | 20 | 730 |
| material 10 | composition 2 | | | | | | | |
| Model | Model material | Preparation Example 2 | Storage Example 4 | NG | — | 140 | 22.4 | 730 |
| material 41 | composition 1 | | | | | | | |
| Model | Model material | Preparation Example 2 | Storage Example 4 | NG | — | 51 | 99 | 730 |
| material 42 | composition 2 | | | | | | | |
| Model | Model material | Preparation Example 2 | Storage Example 4 | NG | — | 102 | 21.4 | 730 |
| material 43 | composition 3 | | | | | | | |
| Model | Model material | Preparation Example 2 | Storage Example 4 | NG | — | 65 | 43 | 730 |
| material 44 | composition 4 | | | | | | | |
| Model | Model material | Preparation Example 2 | Storage Example 4 | NG | — | 15.4 | 39 | 730 |
| material 45 | composition 5 | | | | | | | |
| Model | Model material | Preparation Example 2 | Storage Example 4 | NG | — | 0.07 | 0.012 | 730 |
| material 46 | composition 6 | | | | | | | |
| Model | Model material | Preparation Example 2 | Storage Example 4 | NG | — | 91 | 14.3 | 730 |
| material 47 | composition 7 | | | | | | | |
| Model | Model material | Preparation Example 2 | Storage Example 4 | NG | — | 76 | 41 | 730 |
| material 48 | composition 8 | | | | | | | |
| Support | Support material | Preparation Example 2 | Storage Example 4 | NG | — | 0.10 | 0.015 | 730 |
| material 11 | composition 1 | | | | | | | |
| Support | Support material | Preparation Example 2 | Storage Example 4 | NG | — | 21 | 20 | 730 |
| material 12 | composition 2 | | | | | | | |

Forming Test 1

The following forming test 1 is carried out using the combination of the model material and the support material (model material and support material after storage) according to Table 7. The results are shown in Table 7.

The forming test 1 is carried out after 1 L of each of the model material and the support material is filtered by a profile star A100 filter (filtering accuracy of 10 μm) manufactured by Pall Corporation.

The forming test 1 is carried out using the model material and the support material as a set, in which a cube having a size of 30 mm×30 mm×30 mm is formed by the model material on an aluminum substrate having a size of 100 mm×100 mm and the surrounding thereof is supported by the support portion including the support material.

As a result, regarding dimension failures due to insufficiency of discharge amount and liquid dripping caused by clogging of the nozzles and positional accuracy failure of ink droplets caused by flight curve, a case where a dimension failure having a size of 0.5 mm or more occurs is rated as “NG”, a case where a dimension failure having a size of equal to or more than 0.2 mm to less than 0.5 mm occurs is rated as “G2”, and a case where a dimension failure having a size of less than 0.2 mm occurs is rated as “G1”.

TABLE 7

| Combination of model material | | | |
|---|---|---|---|
| and support material | | Forming test 1 | Remarks |
| Model material 25 | Support material 7 | NG | Comparative |
| | | | Example |
| Model material 26 | Support material 7 | NG | Comparative |
| | | | Example |
| Model material 27 | Support material 7 | NG | Comparative |
| | | | Example |
| Model material 28 | Support material 7 | G1 | Example |
| Model material 29 | Support material 7 | G1 | Example |
| Model material 30 | Support material 7 | G1 | Example |
| Model material 31 | Support material 7 | G1 | Example |
| Model material 32 | Support material 7 | G1 | Example |
| Model material 25 | Support material 8 | NG | Comparative |
| | | | Example |
| Model material 26 | Support material 8 | NG | Comparative |
| | | | Example |
| Model material 27 | Support material 8 | NG | Comparative |
| | | | Example |
| Model material 28 | Support material 8 | G1 | Example |
| Model material 29 | Support material 8 | G1 | Example |
| Model material 30 | Support material 8 | G1 | Example |
| Model material 31 | Support material 8 | G1 | Example |
| Model material 32 | Support material 8 | G1 | Example |

Filter Test 2

The following filter test 2 is carried out using the combination of the model material and the support material (model material and support material after storage) according to Tables 8 to 10. The results are shown in Tables 8 to 10.

First, 1 L each of the model material and the support material is filtered by a profile star A100 filter (filtering accuracy: 10 μm) manufactured by Pall Corporation, and the resultant is further filtered by A050 filter (filtering accuracy of 5 μm). After that, a pressure gauge is disposed immediately before a filter of the forming apparatus, and the total 500 ml of each of the model material and the support material is made to pass through a filter. A case where the pressure shows 0.5 MPa or more (maximum working pressure is 0.65 MPa) is rated as “NG”, a case where the pressure shows equal to or more than 0.1 MPa to less than 0.5 MPa is rated as “G2”, and a case where the pressure shows less than 0.1 MPa is rated as “G1”.

Forming Test 2

The following forming test 2 is carried out using the combination of the model material and the support material (model material and support material after storage) according to Tables 8 to 10. The results are shown in Tables 8 to 10.

The forming test 2 is carried out using the model material and the support material as a set. A cube having a size of 0 mm×50 mm and a thickness of 2 is formed by the model material on an aluminum substrate having a size of 100 mm×100 mm, and the surrounding thereof is supported by the support portion including the support material. The support portion is removed to obtain a structure made of the cube, the structure made of the cube is kept at room temperature (25° C.) for 7 days, and the appearance is visually observed, the surface is observed by a microscope, and a coating test is carried out.

Appearance Observation

The appearance observation is evaluated based on the following standards.
Structure having no glossiness; the surface appears to be white by diffused reflection and no glossiness is felt.
Structure having Glossiness; the surface reflects almost uniformly.

Observation by Microscope

The observation by a microscope is evaluated based on the following standards. In addition, it is considered that a granular substance is formed because the metal soap (fatty acid metal salt) is extruded from the structure (bleed out).
Great number of granular substances; white particulates having a size of several micrometers are observed in all over the surface.
Small number of granular substances; white particulates having a size of several micrometers are sparsely observed.
No granular substances; the particulates are hardly observed.

Coating Test

The coating test is carried out as follows. First, the surface of the structure is coated with an aqueous multipurpose spray (white) coating material manufactured by Asahipen Corporation. The coated structure is kept overnight at room temperature (25° C.) and dried sufficiently, and then the appearance of the structure is observed. In addition, the evaluation is performed based on the following standards. It is considered that the repelling of the coated film is caused by the granular substance precipitated on the surface of the structure.
Nonuniformity; repelling occurs to the extent that the almost uniform coating film cannot be formed.
Occurrence of repelling; repelling is observed in the almost uniform coating film.
Capable of being coated; coating may be performed almost uniformly and repelling is not recognized.

TABLE 8

| Combination of model material | | | Appearance | Observation by | | |
|---|---|---|---|---|---|---|
| and support material | | Filter test 2 | observation | microscope | Coating test | Remarks |
| Model material 1 | Support material 1 | G2 | No | Great number of | Nonuniformity | Comparative |
| | | | glossiness | granular substances | | Example |
| Model material 2 | Support material 1 | G2 | No | Great number of | Nonuniformity | Comparative |
| | | | glossiness | granular substances | | Example |
| Model material 3 | Support material 1 | G2 | No | Great number of | Nonuniformity | Comparative |
| | | | glossiness | granular substances | | Example |
| Model material 4 | Support material 1 | G2 | No | Great number of | Nonuniformity | Comparative |
| | | | glossiness | granular substances | | Example |
| Model material 5 | Support material 1 | G2 | No | Great number of | Nonuniformity | Comparative |
| | | | glossiness | granular substances | | Example |
| Model material 6 | Support material 1 | G2 | No | Great number of | Nonuniformity | Comparative |
| | | | glossiness | granular substances | | Example |
| Model material 7 | Support material 1 | G2 | No | Great number of | Nonuniformity | Comparative |
| | | | glossiness | granular substances | | Example |
| Model material 8 | Support material 1 | G2 | No | Great number of | Nonuniformity | Comparative |
| | | | glossiness | granular substances | | Example |
| Model material 1 | Support material 2 | G2 | No | Great number of | Nonuniformity | Comparative |
| | | | glossiness | granular substances | | Example |
| Model material 2 | Support material 2 | G2 | No | Great number of | Nonuniformity | Comparative |
| | | | glossiness | granular substances | | Example |
| Model material 3 | Support material 2 | G2 | No | Great number of | Nonuniformity | Comparative |
| | | | glossiness | granular substances | | Example |
| Model material 4 | Support material 2 | G2 | No | Great number of | Nonuniformity | Comparative |
| | | | glossiness | granular substances | | Example |
| Model material 5 | Support material 2 | G2 | No | Great number of | Nonuniformity | Comparative |
| | | | glossiness | granular substances | | Example |
| Model material 6 | Support material 2 | G2 | No | Great number of | Nonuniformity | Comparative |
| | | | glossiness | granular substances | | Example |
| Model material 7 | Support material 2 | G2 | No | Great number of | Nonuniformity | Comparative |
| | | | glossiness | granular substances | | Example |
| Model material 8 | Support material 2 | G2 | No | Great number of | Nonuniformity | Comparative |
| | | | glossiness | granular substances | | Example |

TABLE 9

| Combination of model material and | | | Appearance | Observation by | | |
|---|---|---|---|---|---|---|
| support material | | Filter test 2 | observation | microscope | Coating test | Remarks |
| Model material | Support material 7 | G1 | No | Small number of | Occurrence of | Comparative |
| 17 | | | glossiness | granular substances | repelling | Example |
| Model material | Support material 7 | G1 | No | Small number of | Occurrence of | Comparative |
| 18 | | | glossiness | granular substances | repelling | Example |
| Model material | Support material 7 | G1 | No | Small number of | Occurrence of | Comparative |
| 19 | | | glossiness | granular substances | repelling | Example |
| Model material | Support material 7 | G1 | No | No granular | Capable of | Example |
| 20 | | | glossiness | substances | being coated | |
| Model material | Support material 7 | G1 | No | No granular | Capable of | Example |
| 21 | | | glossiness | substances | being coated | |
| Model material | Support material 7 | G1 | No | No granular | Capable of | Example |
| 22 | | | glossiness | substances | being coated | |
| Model material | Support material 7 | G1 | No | No granular | Capable of | Example |
| 23 | | | glossiness | substances | being coated | |
| Model material | Support material 7 | G1 | No | No granular | Capable of | Example |
| 24 | | | glossiness | substances | being coated | |
| Model material | Support material 8 | G1 | Glossy | Small number of | Occurrence of | Comparative |
| 17 | | | | granular substances | repelling | Example |
| Model material | Support material 8 | G1 | Glossy | Small number of | Occurrence of | Comparative |
| 18 | | | | granular substances | repelling | Example |
| Model material | Support material 8 | G1 | Glossy | Small number of | Occurrence of | Comparative |
| 19 | | | | granular substances | repelling | Example |
| Model material | Support material 8 | G1 | Glossy | No granular | Capable of | Example |
| 20 | | | | substances | being coated | |
| Model material | Support material 8 | G1 | Glossy | No granular | Capable of | Example |
| 21 | | | | substances | being coated | |
| Model material | Support material 8 | G1 | Glossy | No granular | Capable of | Example |
| 22 | | | | substances | being coated | |
| Model material | Support material 8 | G1 | Glossy | No granular | Capable of | Example |
| 23 | | | | substances | being coated | |
| Model material | Support material 8 | G1 | Glossy | No granular | Capable of | Example |
| 24 | | | | substances | being coated | |

TABLE 10

| Combination of model material and | | | Appearance | Observation by | | |
|---|---|---|---|---|---|---|
| support material | | Filter test 2 | observation | microscope | Coating test | Remarks |
| Model material | Support material 7 | G1 | No glossiness | Small number of | Occurrence of | Comparative |
| 25 | | | | granular substances | repelling | Example |
| Model material | Support material 7 | G1 | No glossiness | Small number of | Occurrence of | Comparative |
| 26 | | | | granular substances | repelling | Example |
| Model material | Support material 7 | G1 | No glossiness | Small number of | Occurrence of | Comparative |
| 27 | | | | granular substances | repelling | Example |
| Model material | Support material 7 | G1 | No glossiness | No granular | Capable of being | Example |
| 28 | | | | substances | coated | |
| Model material | Support material 7 | G1 | No glossiness | No granular | Capable of being | Example |
| 29 | | | | substances | coated | |
| Model material | Support material 7 | G1 | No glossiness | No granular | Capable of being | Example |
| 30 | | | | substances | coated | |
| Model material | Support material 7 | G1 | No glossiness | No granular | Capable of being | Example |
| 31 | | | | substances | coated | |
| Model material | Support material 7 | G1 | No glossiness | No granular | Capable of being | Example |
| 32 | | | | substances | coated | |
| Model material | Support material 8 | G1 | Glossy | Small number of | Occurrence of | Comparative |
| 25 | | | | granular substances | repelling | Example |
| Model material | Support material 8 | G1 | Glossy | Small number of | Occurrence of | Comparative |
| 26 | | | | granular substances | repelling | Example |
| Model material | Support material 8 | G1 | Glossy | Small number of | Occurrence of | Comparative |
| 27 | | | | granular substances | repelling | Example |
| Model material | Support material 8 | G1 | Glossy | No granular | Capable of being | Example |
| 28 | | | | substances | coated | |
| Model material | Support material 8 | G1 | Glossy | No granular | Capable of being | Example |
| 29 | | | | substances | coated | |
| Model material | Support material 8 | G1 | Glossy | No granular | Capable of being | Example |
| 30 | | | | substances | coated | |
| Model material | Support material 8 | G1 | Glossy | No granular | Capable of being | Example |
| 31 | | | | substances | coated | |
| Model material | Support material 8 | G1 | Glossy | No granular | Capable of being | Example |
| 32 | | | | substances | coated | |

From the above result, it is understood that the model material, in which the total concentration of the magnesium ion and the calcium ion is 50 ppm or less, the concentration of the alkali metal ion is 100 ppm or less and the concentration of the fatty acid compound is 50 ppm or less, exhibits a satisfactory result in the appearance observation, the observation by the microscope, and the coating test. Also, it is understood that the discharge failures are prevented.

Meanwhile, it is understood that in even the support material, in which the total concentration of the magnesium ion and the calcium ion is 50 ppm or less, the concentration of the alkali metal ion is 100 ppm or less, and the concentration of the fatty acid compound is 50 ppm or less, the discharge failures are prevented.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A three-dimension forming material,
comprising a radiation curable compound, and
having a total concentration of a magnesium ion and a calcium ion of 50 ppm or less, a concentration of an alkali metal ion of 100 ppm or less, and a concentration of a fatty acid compound of 50 ppm or less.

2. A three-dimension forming support material,
comprising a radiation curable compound and a plasticizer, and
having a total concentration of a magnesium ion and a calcium ion of 50 ppm or less, a concentration of an alkali metal ion of 100 ppm or less, and a concentration of a fatty acid compound of 50 ppm or less.

3. A three-dimension forming composition set comprising:
the three-dimension forming material according to claim 1; and
a three-dimension forming support material that contains a radiation curable compound and a plasticizer.

4. The three-dimension forming composition set according to claim 3,
wherein the three-dimension forming support material has a total concentration of a magnesium ion and a calcium ion of 50 ppm or less, a concentration of an alkali metal ion of 100 ppm or less, and a concentration of a fatty acid compound of 50 ppm or less.
